(19) United States
(12) Patent Application Publication
(10) Pub. No.: US 2025/0237575 A1
(43) Pub. Date: Jul. 24, 2025

(54) SYSTEMS AND METHODS FOR AUTOMATIC TEST AND TURN-UP OF OPTICAL TRANSPORT SYSTEMS

(71) Applicant: Verizon Patent and Licensing Inc., Basking Ridge, NJ (US)

(72) Inventors: Tiejun J. Xia, Richardson, TX (US); Glenn A. Wellbrock, Wichita, KS (US)

(21) Appl. No.: 18/419,664

(22) Filed: Jan. 23, 2024

(51) Int. Cl. G01M 11/00; H04B 10/071

(52) U.S. Cl. CPC G01M 11/3109; H04B 10/071

(57) ABSTRACT

A device may include a processor. The processor may be configured to send first control signals to optical switches to optically connect embedded optical time domain reflectometers (OTDRs), of an optical network, to optical fibers of the optical network; send second control signals to the OTDRs to measure attenuations of optical signals in the optical fibers; receive measurement data from the OTDRs as results of measuring the attenuations of the optical signals in the optical fibers; process the measurement data; and determine whether the optical fibers meet a performance requirement based on the processed measurement data.

### BACKGROUND INFORMATION

An optical fiber may include a glass or a plastic fiber capable of carrying light for optical telecommunication. When light travels inside an optical fiber, the light may suffer from scattering, however. When a light beam is scattered within an optical fiber, the beam attenuates as the scattered light transfers energy away from the modes of the original beam to other modes. Scattering may be caused by heterogeneity in material density within the optical fiber due to, for example, impurities added to the fiber, temperature variations along the fiber, and/or cracks in the fiber. Scattering may be linear or non-linear. In linear scattering, such as Rayleigh scattering, the scattered light has the same frequency as the original beam. In non-linear scattering, such as Brilliouin scattering, the scattered light has frequencies different from those of the original beam.

An optical measurement device may apply linear scattering and/or non-linear scattering to detect flaws in optical fibers. For example, an optical time domain reflectometer (OTDR) may measure attenuation of light traveling in an optical fiber based on backscattering (e.g., scattering of the light back to the OTDR). To measure the loss of power of light traveling in an optical fiber, an OTDR may inject short pulses of laser into the core of the optical fiber via a wave coupler and measure the power levels of pulses backscattered from various points along the optical fiber. A loss in power greater than a threshold may indicate that the optical fiber has a flaw.

### BRIEF DESCRIPTION OF THE DRAWINGS

FIG. 1A illustrates manually testing optical fibers of an optical network.

FIG. 1B illustrates manually performing attenuation measurements on optical fibers between two endpoints.

FIG. 2 illustrates exemplary graphs of power loss curves of an optical fiber.

FIG. 3A illustrates an example optical network that may be tested and turned up according to an implementation.

FIG. 3B depicts an optical network that includes embedded optical time domain reflectometers (OTDRs), according to an implementation.

FIGS. 4A-4D illustrate a system, for performing an automatic test and turn-up (TTU) of an optical network, in various stages of its construction, according to an implementation.

FIGS. 5A-5B illustrate a system, for performing an automatic TTU of an optical network, in various stages of its construction, according to another implementation.

FIG. 6 is a flow diagram of an example process that is associated with a system for performing automatic TTU of an optical network according to an implementation.

FIG. 7 depicts example functional components of a network device according to an implementation.

### DETAILED DESCRIPTION

The following detailed description refers to the accompanying drawings. The same reference numbers in different drawings may identify the same or similar elements. As used herein, the term “test and turn-up” (TTU) may refer to one of the last stages in deployment of a network, during which the network components are installed and tested. A TTU may determine whether all network equipment is connected correctly, verify software, troubleshoot problems, and/or resolve any identified issues and prepare the network for operation. A turn-up of an optical network may include testing optical fibers.

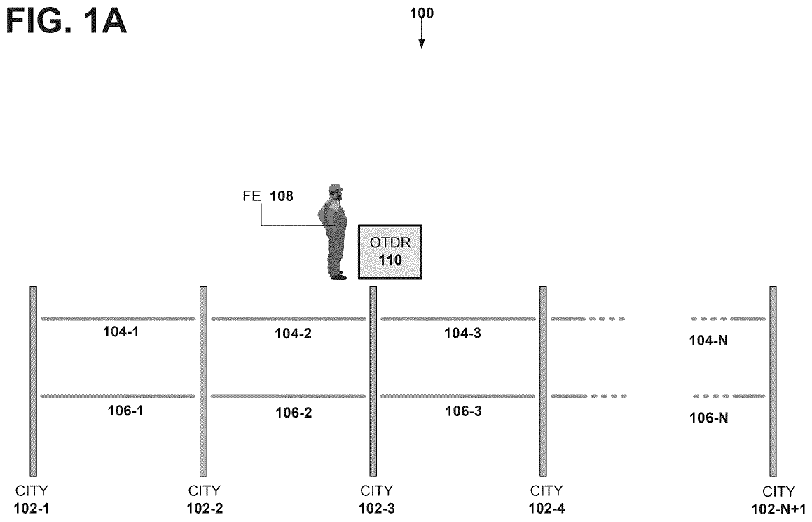

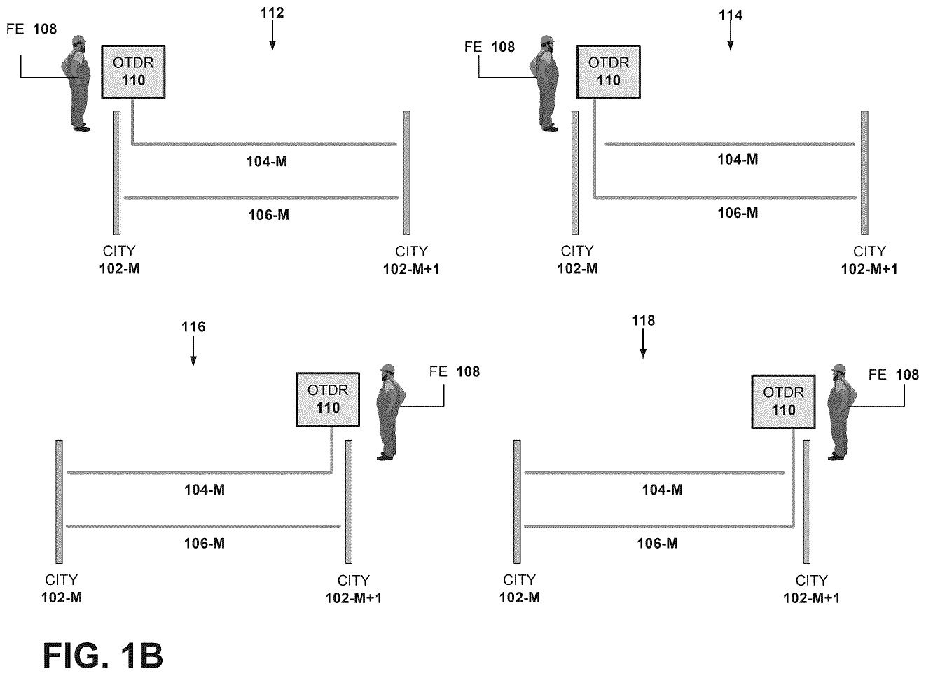

Systems and methods described herein relate to automatic TTU of optical networks and/or systems. FIG. 1A illustrates manual testing, of optical fibers of an optical transport system, as part of a TTU that may be automated by the systems described herein. As shown, an optical network 100 includes pairs of optical fibers 104-1 and 106-1 through 104-N and 106-N. Optical fibers 104-1 through 104-N (collectively referred to as optical fibers 104 and generically as optical fiber 104) may carry optical signals from the left to the right and optical fibers 106-1 through 106-N (collectively referred to as optical fibers 106 and generically as optical fiber 106) may carry optical signals from the right to the left. Each pair 104 and 106 may connect nodes, herein illustrated as cities 102-1 through 102-N. In particular, given M where 1≤M<N, each pair of optical fibers 104-M and 106-M may connect node 102-M and node 102-M+1, a portion herein referred to as M^{th} span.

Assume that as part of the turn-up of the optical network 100, a field engineer (FE) 108 may be dispatched to test optical fibers 104 and 106 at each of the endpoints of fibers 104 and 106. For example, field engineer 108 may test optical fibers 104-3 and 106-3 at nodes 102-3 and 102-4 (e.g., 3^{rd} span). In testing optical fibers 104 and 106, field engineer 108 may measure the attenuation of optical signals along fibers 104 and 106 using a measurement device, such as an optical time domain reflectometer (OTDR) 110. If measurements indicate that optical fiber 104/106 is faulty, field engineer 108 may repair or replace optical fiber 104/106. For example, if measurements indicate that optical fiber 104-3 includes a fractured segment, field engineer 108 may splice in a new segment in optical fiber 104-3.

In FIG. 1A, for field engineer 108 to accurately determine the attenuation of optical fibers 104 and 106, field engineer 108 may need to perform at least four loss measurements using OTDR 110. FIG. 1B illustrates manually performing four attenuation measurements 112, 114, 116, 118 on optical fibers 104-M and 106-M between two endpoints (shown as cities 102-M and 102-M+1). As depicted, for measurement 112, field engineer 108 may optically connect OTDR 110 to one end of optical fiber 104-M, at node 102-M. During the measurement, OTDR 110 sends pulses of laser beam into optical fiber 104-M. For each pulse reflected back to OTDR 110 due to backscattering, OTDR 110 may measure the power of the reflected pulse and the distance which the reflected pulse traveled to reach OTDR 110 (determined by measuring the time delay between the pulse transmitted by OTDR 110 and the reflected pulse). For measurement 114, field engineer 108 performs a similar measurement on optical fiber 106-M at node 102-M. For measurements 116 and 118, field engineer 108 makes measurements of optical fibers 104-M and 106-M at the other ends of optical fibers 104-M and 106-M+1, at node 102-M+1. That is, in FIG. 1B, field engineer 108 makes two measurements for each of the optical fibers 104-M and 106-M, at the opposite ends. The reason for taking two measurements for each optical fiber at the opposite ends is that the Rayleigh back-scattering coefficient for the optical fiber may vary along its length, which can result in false loss readings or false gain readings by OTDR 110.

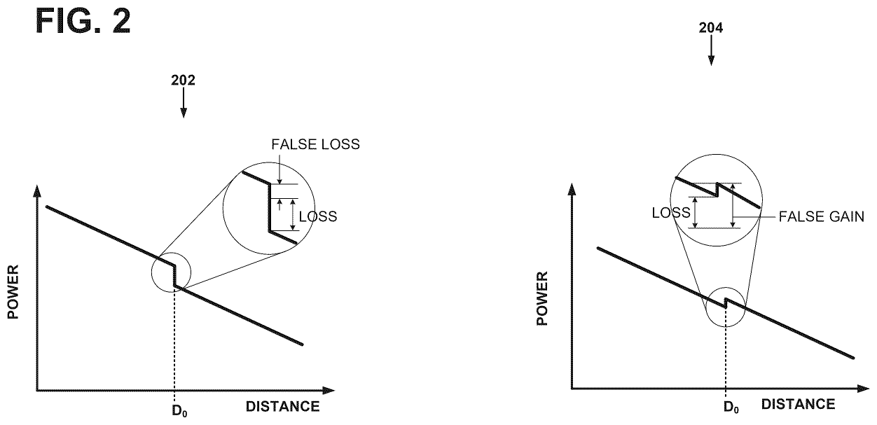

FIG. 2 illustrates exemplary graphs 202 and 204 of power loss curves of an optical fiber. Graphs 202 and 204 may be obtained by plotting power loss measurements of an optical fiber in the opposite directions, using OTDR 110. Graph 202 shows a power loss curve based on the measured powers of pulses reflected at points between node M and node M+1 (e.g., the end points). The measurements have been performed at node M in the direction toward node M+1. As shown, the power of the reflected pulses may decrease with increasing distance from OTDR 110 along the optical fiber. At distance Do, however, the power drops precipitously. As further shown, the drop may comprise an actual loss and a false loss, primarily due to a sudden change in the Rayleigh coefficient within the optical fiber.

Graph 204 shows a power loss curve based on the measured powers of pulses reflected at points between node M+1 and node M. The measurements have been performed at node M+1 in the direction toward node M. As shown, the power of reflected pulses may decrease with increasing distance from the OTDR 110 along the optical fiber. At distance Di from OTDR 110 at node M+1 (which corresponds to distance Do away from node M), however, the power jumps abruptly. As further shown, the jump may comprise a loss and a false gain, primarily due to a sudden change in the Rayleigh coefficient within the optical fiber.

Because power loss measurements of an optical fiber can include a false loss and/or a false gain, to obtain an actual gain/loss data along an optical fiber, it may be necessary to make two measurements of the optical fiber in opposite directions. The actual loss along an optical fiber can be determined or calculated by taking a first measurement and a second measurement in two opposite directions (e.g., at the opposite ends) and averaging the first measurement and the second measurement for each point on the optical fiber. By averaging the measurements, the false loss or the false gain may be eliminated to obtain the actual loss.

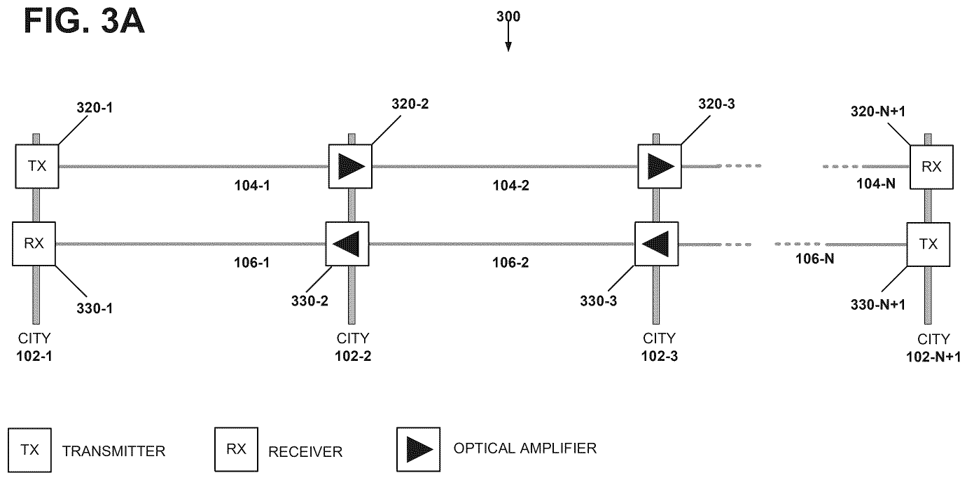

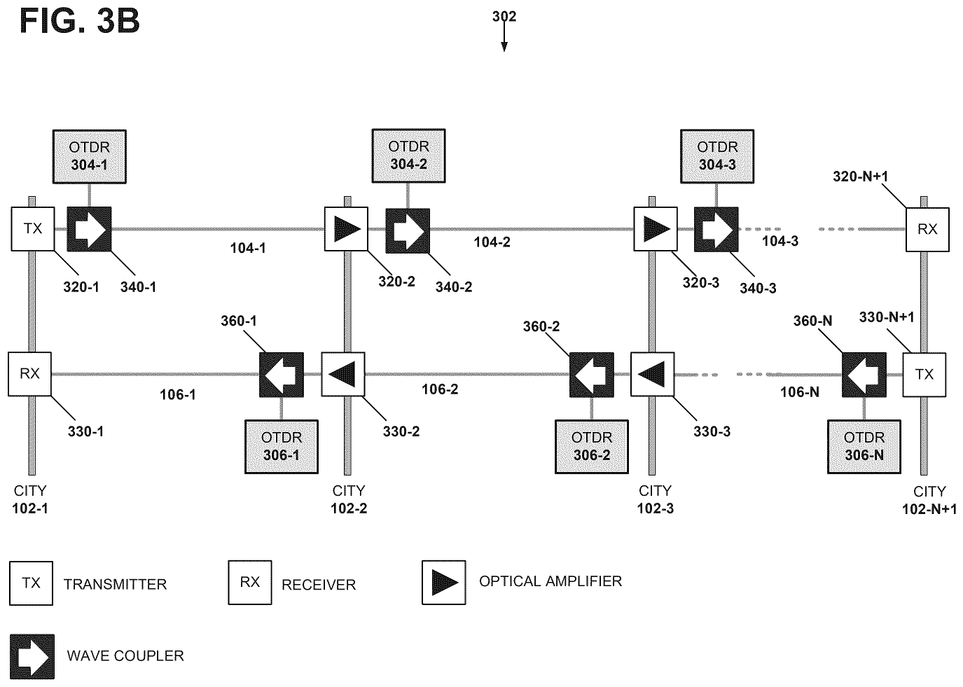

FIG. 3A illustrates an example optical network 300 that may be tested and turned up according to an implementation. Although in FIG. 3A, for clarity, optical network 300 is depicted as including only optical fibers, optical amplifiers, optical transmitters, and optical receivers, in practice, optical network 300 may include additional, fewer, different, or a different arrangement of components other than those shown.

Referring to FIG. 3A, optical fibers 104 of network 300 are terminated by an optical transmitter 320-1 at node 102-1 (e.g., a laser), optical amplifiers 320-2 through 320-N at nodes 2 through N, and an optical receiver 320-N+1 at node 102-N+1. As an optical signal that originated from the optical transmitter 320-1 travels along inside optical fibers 104, it is amplified by optical amplifiers 340 at or near each node, to compensate for attenuation and to restore the signal power. Similarly, optical fibers 106 may be terminated by an optical transmitter 330-N+1 at node 102-N+1 (e.g., a laser), optical amplifiers 330-N through 330-2 at nodes N through 2, and an optical receiver 330-1 at node 102-1. As an optical signal that originated from the optical transmitter 330-N+1 at node 102-N+1 travels along inside optical fibers 106, it is amplified by optical amplifiers 360 at or near each node, to compensate for attenuation and to restore the signal power to acceptable levels. No amplifier is included at the transmitters 320-1 of node 102-1 or transmitter 330-N+1 of node 102-N+1 for optical fibers 104-1 and 106-N. It is assumed that the transmitters are adjusted to provide optical signals at appropriate power levels.

FIG. 3B illustrates an optical network 302 that may be tested and turned up according to an implementation. Although in FIG. 3B, for clarity, optical network 302 is depicted as including only optical fibers, optical amplifiers, optical transmitters, optical receivers, OTDRs, and wave couplers, in practice, optical network 302 may include additional, fewer, different, or a different arrangement of components other than those shown.

Referring to FIG. 3B, optical network 302 may include not only the components of optical network 300 but also embedded OTDRs 304-1 through 304-N and 306-1 through 306-N and wave couplers 340-1 through 340-N and 360-1 through 360-N. For example, for each M^{th} span (1≤M<N+1), an embedded OTDRs 304/306 may be optically connected to optical fiber 104/106 via wave couplers 340/360. Embedded OTDR 304/306 and a wave coupler 340/360 may be built into network 302. Each wave coupler 340/360 optically connects OTDR 304/306 to optical fiber 104/106 near one optical fiber end, so that OTDR 304/306 can inject laser pulses into optical fiber 104/106 and receive the backscattered pulses from optical fiber 104/106. In optical network 302, embedded OTDRs 304/306 are used to measure attenuation of optical signals during operation of network 302 and not specifically for a TTU. For optical fibers 104/106, embedded OTDRs 304/306 are positioned only at one endpoint of optical fiber 104/106, and therefore, cannot be used to render two measurements that are necessary to obtain accurate power loss curves without portions that reflect false gains/losses.

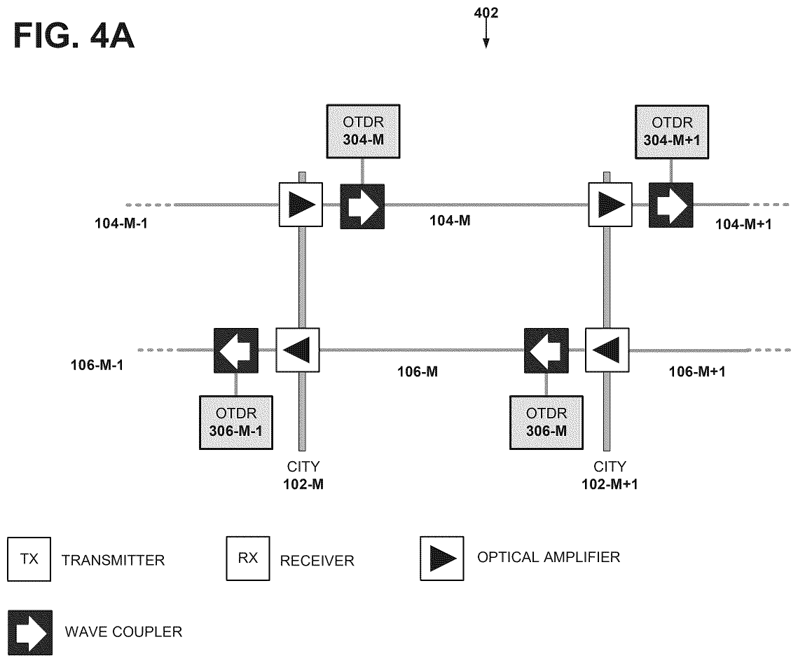

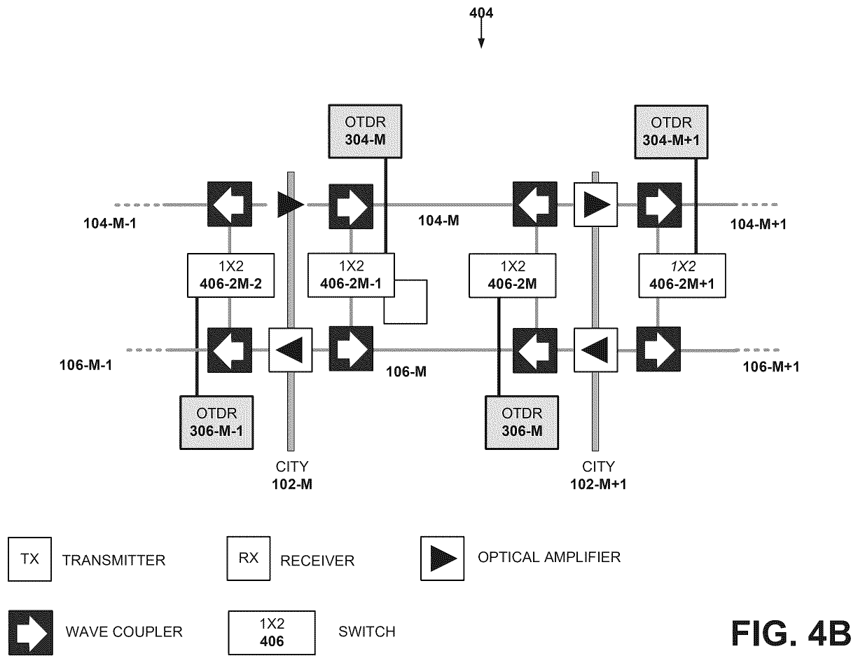

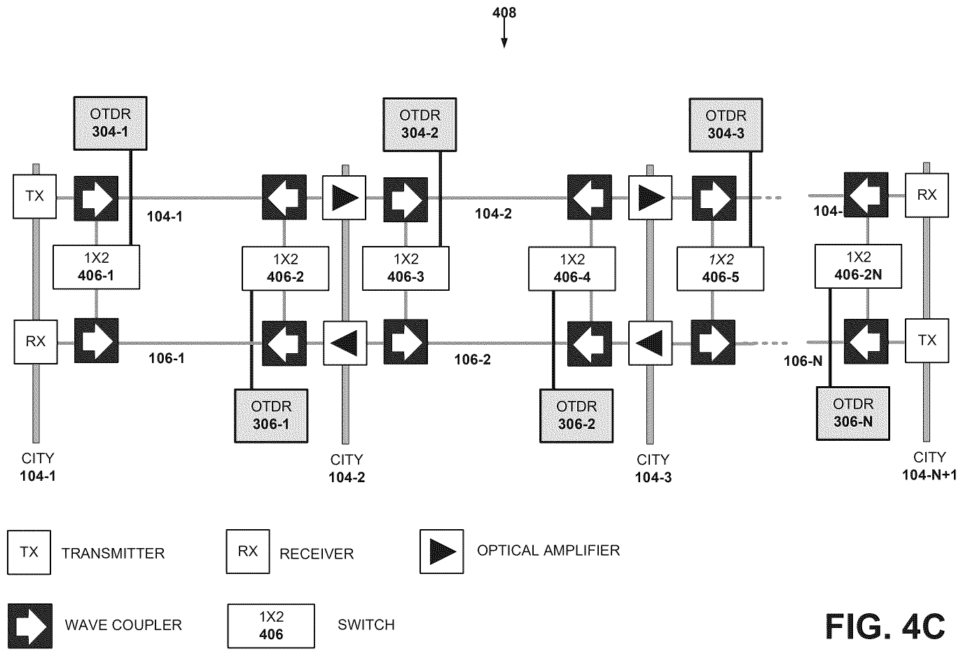

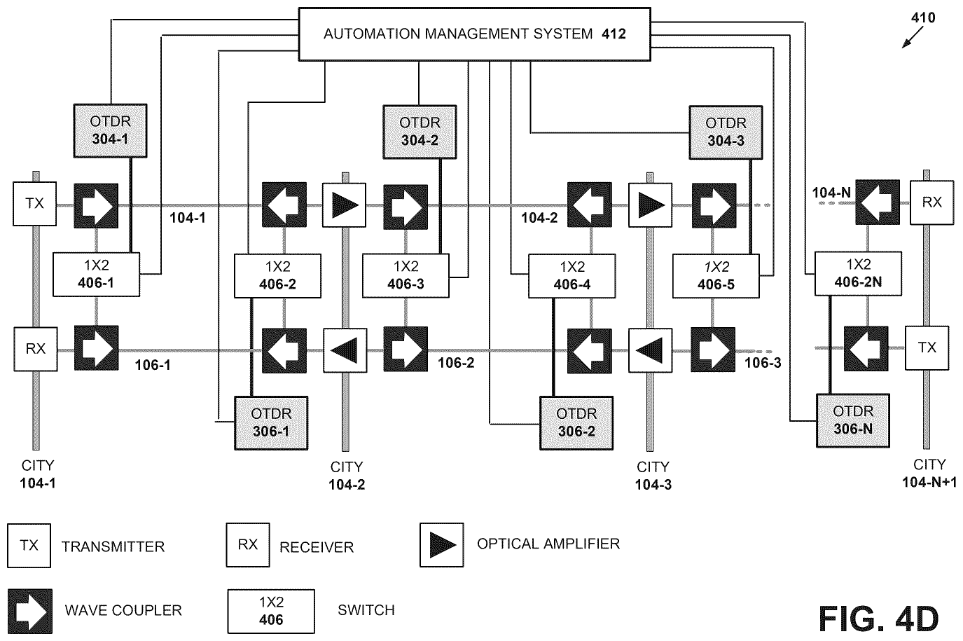

FIGS. 4A-4D illustrate a system, for performing an automatic TTU of an optical network, in various stages of its construction, according to implementations. Although in FIGS. 4A-4D, for clarity, the optical networks are depicted as including only optical fibers, optical amplifiers, optical transmitters, optical receivers, embedded OTDRs, wave couplers, and optical switches, in practice, the optical networks may include additional, fewer, different, or a different arrangement of components other than those shown. In FIGS. 4A-4D, the numerical labels for the optical transmitters, optical receivers, wave couplers, and optical amplifiers are omitted to avoid cluttering FIGS. 4A-4D but can be assumed to be as same as those in optical network 302.

FIG. 4A shows an M^{th} span 402 of optical network 302, where 2≤M<N. M^{th} span 402 is simply a portion of optical network 302 of FIG. 3B, with the components labeled using the index M. For example, in FIG. 4A, optical network span 402 includes an embedded OTDR 304-M near node M (just after amplifier 320-M) optically connected to optical fiber 104-M via a wave coupler 340-M. In another example, optical network span 402 includes an embedded OTDR 306-M near node M+1 (just after the amplifier 330-M) optically connected to optical fiber 106-M via a wave coupler 360-M. As indicated above with reference to FIG. 3B, the configuration of network 302 may not be used to make two measurements that are necessary to obtain accurate power loss curves that do not reflect false gains/losses.

FIG. 4B shows the M^{th} span (2≤M<N+1) 404 that may be obtained from optical network span 402 by including optical switches and additional wave couplers. As shown, span 404 includes, near node 102-M, OTDR 304-M coupled to a 1×2 optical switch 406-2M-1. The output optical lines of 1×2 optical switch 406-2M-1 are connected to a wave coupler on optical fiber 104-M and to a wave coupler on optical fiber 106-M. Depending on the settings of 1×2 optical switch 406-2M-1, OTDR 304-M may be optically connected, via 1×2 optical switch 406-2M-1, to either the wave coupler of optical fiber 104-M or the wave coupler of optical fiber 106-M. Via 1×2 optical switch 406-2M-1, OTDR 304-M may take power loss measurements for either optical fiber 104-M or optical fiber 106-M, in the direction from node M toward node M+1.

Similarly, as also shown, near node 102-M+1, OTDR 306-M is coupled to a 1×2 optical switch 406-2M. The output lines of 1×2 optical switch 406-2M are connected to a wave coupler on optical fiber 104-M and a wave coupler on optical fiber 106-M. Depending on the settings of 1×2 optical switch 406-2M, OTDR 306-M may be coupled, via 1×2 optical switch 406-2M, to either a wave coupler of optical fiber 104-M or a wave coupler of optical fiber 106-M. Via 1×2 optical switch 406-2M, OTDR 306-M may take power loss measurements for either optical fiber 104-M or optical fiber 106-M, in the direction from node M+1 toward node M.

Accordingly, in FIG. 4B, with correct settings of optical switches 306-2M-1 and 306-2M, OTDR 304-M may take power loss measurements of optical fibers 104-M and 106-M near or at node M in the direction toward node M+1; and OTDR 306-M make take power loss measurements of optical fibers 304-M and 106-M near or at node M+1 in the direction toward node M. That is, using OTDR 304-M and 306-M, power loss measurements for optical fibers 104-M and 106-M may be made in two opposite directions.

FIG. 4C shows an example optical network 408. As shown, optical network 408 includes spans whose configurations are identical to that of span 404, except that in the 1st span and the N^{th} span of optical network 408, optical transmitters and optical receivers (rather than optical amplifiers) terminate optical fibers 104-1 and 106-1 near node 102-1 and terminate optical fibers 104-N and 106-N near node 102-N+1.

FIG. 4D shows an example optical network 410 that may be constructed by combining optical network 408 with an automation management system 412. As shown, automation management system 412 is connected to OTDRs 304 and 306 and optical switches 406 for controlling the OTDRs 304 and 306 and optical switches 406 and for receiving data (e.g., measurement readings) from OTDRs 304 and 306.

In operation, automation management system 412 may perform a TTU of optical network 410. For example, automation management system 412 may obtain power loss curves for optical fibers 104 and 106 in each of N spans as part of a TTU. To obtain an accurate power loss curve (e.g., without false losses or gains) for optical fiber 104-2 in the 2^{nd} span, for example, automation management system 412 may make power loss measurements of optical fiber 104-2 using OTDRs 304-2 and 306-2 in opposite directions. More specifically, automation management system 412 may configure optical switch 106-3 so that OTDR 304-2 is optically coupled only to optical fiber 104-2; configure optical switch 406-4 so that OTDR 306-2 is not optically coupled to optical fiber 104-2 (e.g., configure optical switch 406-4 so that OTDR 306-2 is only optically connected to optical fiber 106-2); and make power loss measurements of optical fiber 104-2 in the direction from node 102-2 to node 102-3 using OTDR 304-2. Next, automation management system 412 may configure optical switch 406-3 so that OTDR 304-2 is optically uncoupled to optical fiber 104-2; configure optical switch 406-4 so that OTDR 306-2 is optically coupled to optical fiber 104-2; and take power loss measurements of optical fiber 104-2 in the direction from node 102-3 to node 102-2 using OTDR 306-2. Automation management system 412 may use the measurements for optical fiber 104-2 from OTDRs 304-2 and 306-2 to obtain a power loss curve without false losses/gains.

Similarly, to obtain an accurate power loss curve, for optical fiber 106-2 in the 2nd span, automation management system 412 may make power loss measurements of optical fibers 106-2 using OTDRs 304-2 and 306-2 in opposite directions. More specifically, automation management system 412 may configure optical switch 106-3 so that OTDR 304-2 is optically coupled only to optical fiber 106-2; configure optical switch 406-4 so that OTDR 306-2 is not optically coupled to optical fiber 106-2 (e.g., set optical switch 406-4 so that OTDR 306-2 is only optically connected to optical fiber 104-2); and make power loss measurements of optical fiber 106-2 in the direction from node 102-2 to node 102-3 using OTDR 304-2. Next, automation management system 412 may configure optical switch 106-3 so that OTDR 304-2 is optically uncoupled to optical fiber 106-2; configure optical switch 406-4 so that OTDR 306-2 is optically coupled to optical fiber 106-2; and take power loss measurements of optical fiber 106-2 in the direction from node 102-3 to node 102-2 using OTDR 306-2. Automation management system 412 may then use the measurements for optical fiber 106-2 from OTDRs 304-2 and 306-2 to obtain a power loss curve without false losses/gains.

After automation management system 412 makes accurate power loss measurements for optical fibers 104 and 106, automation management system 412 may analyze the power loss curve to detect any problems with optical fibers 104 and 106 (e.g., a sudden drop. in power at a point, which is greater than a threshold, an overall attenuation greater than another threshold, etc.). In some implementations, automation management system 412 may use the OTDRs 304 and 306 to make Brillouin scattering measurements to detect optical fiber strain or temperature variations along the fiber.

Automation management system 412 may make backscattering measurements of optical fibers 104/106 and analyze the results during the TTU of optical network 410 and/or during normal operation of optical network 410. Thus, for example, automation management system 412 may detect any issues, with optical fibers 104/106, which may arise over time due to temperature variations in the environment, by making periodic backscattering measurements of optical fibers 104/106 and analyzing the results.

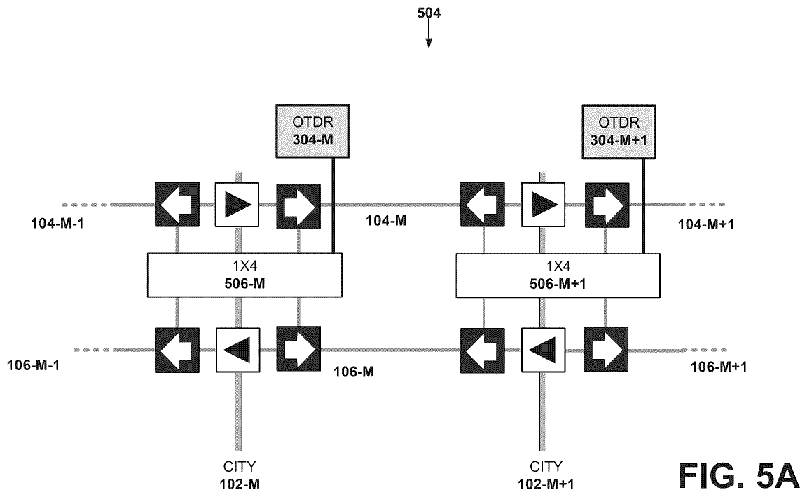

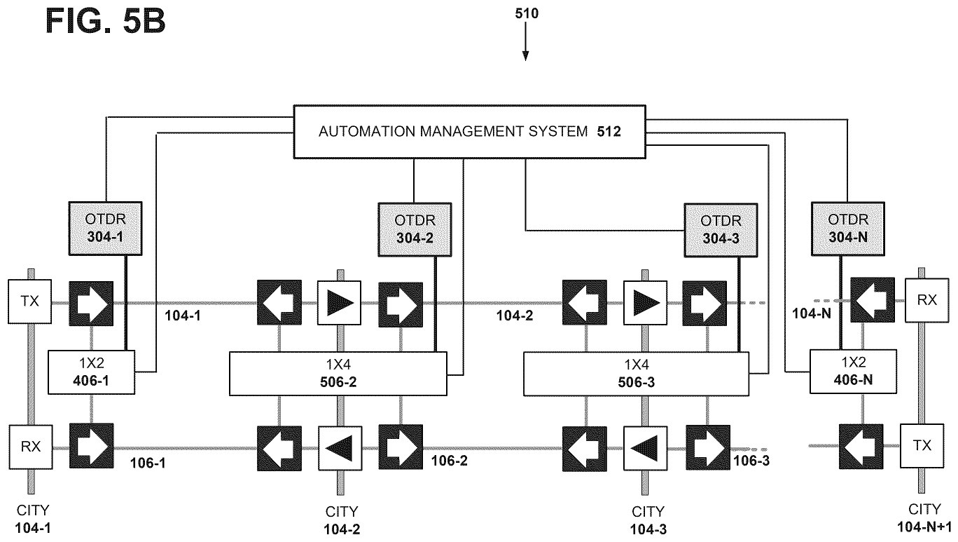

FIGS. 5A-5B illustrate a system, for performing an automatic TTU of an optical network, in various stages of its construction, according to another implementation. Although in FIGS. 5A and 5B, for clarity, the optical networks are depicted as including only optical fibers, optical amplifiers, optical transmitters, optical receivers, OTDRs, wave couplers, and optical switches, in practice, the optical networks may include additional, fewer, different, or a different arrangement of components other than those shown.

FIG. 5A shows the M^{th} span (2≤M<N+1) 504, of an optical network, which may be obtained from optical network span 402 by including 1×4 optical switches and additional wave couplers and removing OTDRs 306. As shown, span 504 includes, near node 102-M, OTDR 304-M coupled directly to a 1×4 optical switch 506-M. The output lines of 1×4 optical switch 506-M are connected to four wave couplers: a wave coupler on optical fiber 104-M (on the right side of node 102-M); a wave coupler on optical fiber 104-M−1 (on the left side of node 102-M); a wave coupler on optical fiber 106-M (on the right side of node 102-M); and a wave coupler on optical fiber 106-M−1. Depending on the configuration of 1×4 optical switch 506-M, OTDR 304-M may be coupled, via 1×4 optical switch 406-M, any one of the four wave couplers. At each span pf an optical network, the corresponding OTDR, wave couplers, and 1×4 switch may be configured similarly as those for span M.

In FIG. 5A, via 1×4 optical switch 506-M and 506-M+1, OTDR 306-M and OTDR 306-M+1 may take power loss measurements for either optical fiber 104-M and/or optical fiber 106-M either from node M to node M+1 or from node M+1 to node M. That is, with appropriate settings on 1×4 switches, by using OTDR 304-M and 304-M+1, power loss measurements for optical fibers 104-M and 106-M may be made in two opposite directions.

FIG. 5B shows example optical network 510 that may be obtained by combining an automation management system 512 and an optical network that includes, for each of its span (except the first and the last span), the components of optical span 504. As shown, automation management system 512 is connected to OTDRs 304 and optical switches 506 for controlling the OTDRs 304 and switches 506 and for receiving data (e.g., measurement readings) from OTDRs 304. For the first and the N^{th} span, optical switches 506-1 and 506-N include 1×2 optical switches rather than 1×4 optical switches.

In operation, automation management system 512 may perform a TTU of optical network 510. For example, automation management system 512 may obtain power loss curves for optical fibers 104 and 106 in each of N spans as part of a TTU. To obtain an accurate power loss curve (e.g., without false losses or gains) for optical fiber 104-2 in the 2nd span, for example, automation management system 512 may make power loss measurements of optical fiber 104-2 using OTDRs 304-2 and 304-3 in opposite directions. More specifically, automation management system 512 may configure optical switch 506-2 so that OTDR 304-2 is optically coupled only to optical fiber 104-2; configure optical switch 506-3 so that OTDR 306-3 is not optically coupled to optical fiber 104-2 (e.g., configure switch 506-3 so that OTDR 304-3 is only optically connected to optical fiber 104-3, 106-2, or 106-3); and make power loss measurements of optical fiber 104-2 in the direction from node 102-2 to node 102-3 using OTDR 304-2. Next, automation management system 512 may configure switch 506-2 so that OTDR 304-2 is optically uncoupled to optical fiber 104-2; set switch 506-3 so that OTDR 304-3 is optically coupled to optical fiber 104-2; and take power loss measurements of optical fiber 104-2 in the direction from node 102-3 to node 102-2 using OTDR 304-3. Automation management system 412 may then use the measurements for optical fiber 104-2 from OTDRs 304-2 and 304-3 to obtain a power loss curve without false losses/gains.

Similarly, to obtain an accurate power loss curve, for optical fiber 106-2 in the 2nd span, automation management system 512 may make power loss measurements of optical fiber 106-2 using OTDRs 304-2 and 304-3 in opposite directions. More specifically, automation management system 512 may configure switch 506-2 so that OTDR 304-2 is optically only coupled to optical fiber 106-2; set switch 506-3 so that OTDR 304-3 is not optically coupled to optical fiber 106-2 (e.g., configure switch 506-3 so that OTDR 304-3 is optically connected to optical fiber 104-2, 104-3, or 106-3); and make power loss measurements of optical fiber 106-2 in the direction from node 102-2 to node 102-3 using OTDR 304-2. Next, automation management system 512 may configure optical switch 506-2 so that OTDR 304-2 is optically uncoupled to optical fiber 106-2; configure optical switch 506-3 so that OTDR 304-3 is optically coupled to optical fiber 106-2; and take power loss measurements of optical fiber 106-2 in the direction from node 102-3 to node 102-2 using OTDR 304-3. Automation management system 512 may then use the measurements for optical fiber 106-2 from OTDRs 304-2 and 304-3 to obtain a power loss curve without false losses/gains.

After automation management system 512 makes accurate power loss measurements for optical fibers 104 and 106, automation management system 512 may analyze the power loss curve to detect any problems with optical fibers 104 and 106 (e.g., detect a sudden drop, within a power loss curve at a point, which is greater than a threshold, an overall attenuation greater than another threshold, etc.). In some implementations, automation management system 512 may use the OTDRs 304 to make Brillouin scattering measurements to detect optical fiber strain or temperature variations along the fibers 104 and 106.

Automation management system 512 may make backscattering measurements of optical fibers 104/106 and analyze the results during the TTU of optical network 510 and/or during normal operation of optical network 510. For example, automation management system 512 may detect any issues, with optical fibers 104 and 106, which may arise over time due to temperature variations in the environment, by making periodic backscattering measurements of optical fibers 104 and 106 and analyzing the results.

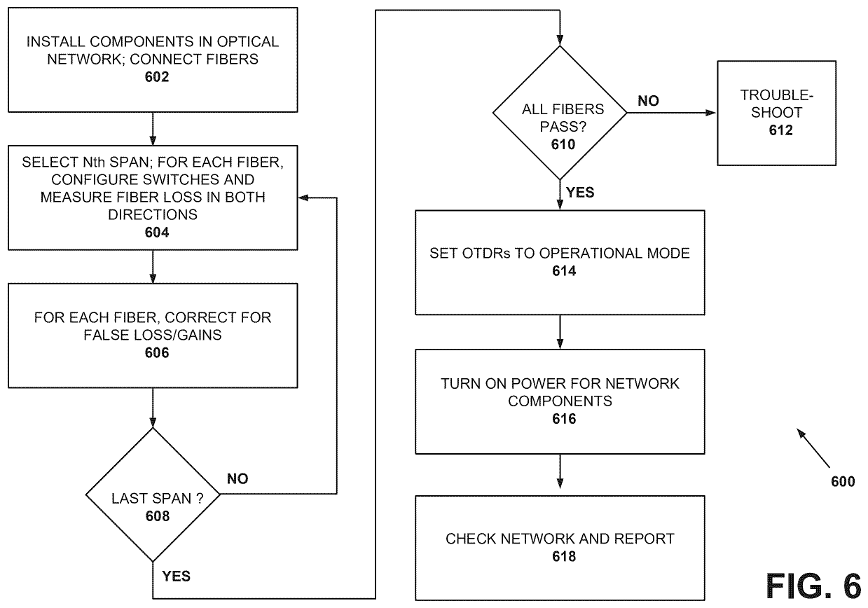

FIG. 6 is a flow diagram of an example process 600 that is associated with a system (e.g., optical network 410 or 510) for performing automatic TTU of an optical network according to an implementation. Process 600 may be performed by various components of optical network 410 or 510, such as automation management system 412/512, OTDRs, optical switches, wave couplers, etc. As shown, process 600 may include installing components in an optical network (block 602) and connecting optical fibers in the optical network. For example, optical transmitters, optical receivers, optical amplifiers, optical switches, and/or OTDRs may be installed within an optical network; and optical fibers of the optical network may be connected.

Process 600 may further include selecting an N^{th} span of the optical network (block 604); configuring optical switches (e.g., 1×2 switches 406, 1×4 switches 506), and measure fiber loss in both directions. For example, as described in FIGS. 4D and 5B, automation management system 412/512 may configure optical switches 406/506 and make power loss measurements for optical fibers 104 and 106 in both directions. Automation management system 412/512 may use the measurements in both directions to correct false gains/losses in the measurements (block 606).

Process 600 may further include determining whether the span for which the measurements have been made is the last span, in the optical network, for testing (block 608). If the span is the last span (block 608: NO), process 600 may return to block 604. Otherwise, process 600 may proceed to block 610 to determine if all of optical fibers of the optical network pass the requirements (block 610). For example, automation management system 412/512 may determine whether the power loss curves of the fibers do not include drops greater than a threshold and/or the overall attenuation of the optical fiber is less than a threshold, If all fibers do not pass (block 610: NO), automation management system 412/512 may initiate troubleshooting (e.g., notify a field engineer) to identify optical fibers with problems and to repair or replace the identified optical fibers (block 612). On the other hand, if all optical fibers pass (block 610: YES), process 600 may proceed to block 614.

Process 600 may further include setting OTDRs of the optical network to be in network operational mode (block 614). For example, after the completion of a TTU for optical network 410/510, automation management system 412/512 may configure embedded OTDRs 304/306 to be in the operational mode (e.g., the mode in which OTDRs 304 and 306 make backscattering measurements for the optical fibers during operation of optical network 410/510). In addition, power may be turned on for the optical components (block 616). For example, automation management system 412/512 may turn on power for optical devices/components of optical network 410/510, such as the optical amplifiers, optical switches, optical transmitters, and optical receivers. Once optical network is operational, the operational network may be checked and reports may be sent to network operators (block 618). For example, automation management system 412/512 may perform testing of optical components periodically or on demand and report the results of the testing to network operators, field engineers, and/or other network devices (e.g., an Operation, Administration, and Maintenance (OAM) device).

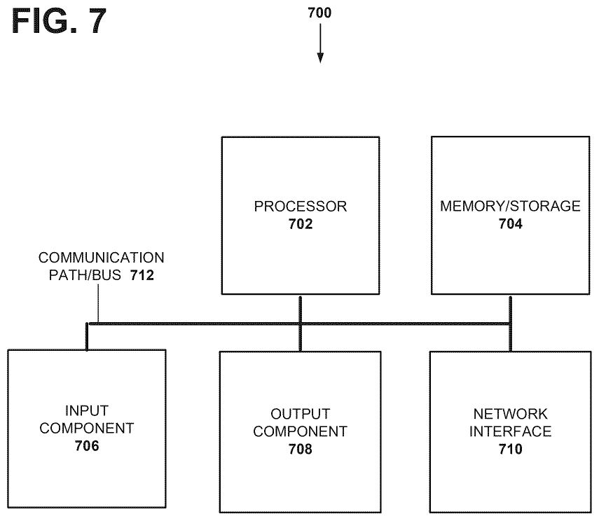

FIG. 7 depicts exemplary components of an exemplary network device 700. Network device 700 may correspond to or be included in any of the devices and/or components illustrated in FIGS. 1A-5B (e.g., OTDRs, optical switches, optical amplifiers, optical transmitters, optical receivers, automation management system 412/512, etc.). In some implementations, network devices 700 may be part of a hardware network layer on top of which other network layers and network functions (NFs) may be implemented.

As shown, network device 700 may include a processor 702, memory/storage 704, input component 706, output component 708, network interface 710, and communication path/bus 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage 704 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700.

Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 700 to communicate with other devices and/or systems. For example, via network interface 710, network device 700 may communicate over a network, such as the Internet, an intranet, cellular, a terrestrial wireless network, a satellite-based network, optical network, etc. Network interface 710 may include a modem, an Ethernet interface to a LAN, and/or an interface/connection for connecting network device 700 to other devices.

Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions have been described with reference to FIG. 6, the order of the actions may be modified in other implementations. In addition, non-dependent actions may represent actions that can be performed in parallel and in different orders. Furthermore, each of actions may include one or more other actions. Additionally, many different optical devices have been described with reference to FIGS. 1A-5B. It should be understood that the principles of operation of optical network components are different from those of electrical counterparts, as optical devices work with or operate on optical signals (e.g., light) (other than the control inputs, electrical outputs from data lines, etc.) rather than on currents/voltages. Accordingly, it is not possible to replace an optical transmitter, an optical amplifier, a wave coupler, a 1×2 optical switch, a 1×4 optical switch, or an optical receiver in an optical network with a corresponding electrical counterpart.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. A device comprising:
a processor to:
send first control signals to optical switches to optically connect embedded optical time domain reflectometers (OTDRs), of an optical network, to optical fibers of the optical network;
send second control signals to the OTDRs to measure attenuations of optical signals in the optical fibers;
receive measurement data from the OTDRs as results of measuring the attenuations of the optical signals in the optical fibers;
process the measurement data; and
determine whether the optical fibers meet a performance requirement based on the processed measurement data.

2. The device of claim 1, wherein the optical switches include one or more of:
1×2 optical switches; or
1×4 optical switches.

3. The device of claim 1, wherein the measurement data includes power loss measurement data for a set of optical signals, in an optical fiber, in two opposite directions.

4. The device of claim 3, wherein when processing the measurement data, the processor is further configured to:
use the power loss measurement data for the optical signals in the two directions to eliminate false gains and false losses in the measurement data.

5. The device of claim 1, wherein the optical network includes waver couplers that optically connect the optical switches to the optical fibers.

6. The device of claim 1, wherein the processor is further configured to:
configure the OTDRs to operate during normal operation of the optical network; and
obtain periodic measurement data from the OTDRs during the normal operation of the optical network.

7. The device of claim 6, wherein the periodic measurement data includes Brillouin backscattering data.

8. The device of claim 6, wherein when the processor sends first control signals to the optical switches, the processor sends the first control signals prior to the normal operation of the optical network.

9. The device of claim 1, wherein the optical network includes at least one or more of:
optical transmitters, optical receivers, and optical amplifiers.

10. A method comprising:
sending first control signals to optical switches to optically connect embedded optical time domain reflectometers (OTDRs), of an optical network, to optical fibers of the optical network;
sending second control signals to the OTDRs to measure attenuations of optical signals in the optical fibers;
receiving measurement data from the OTDRs as results of measuring the attenuations of the optical signals in the optical fibers;
processing the measurement data; and
determining whether the optical fibers meet a performance requirement based on the processed measurement data.

11. The method of claim 10, wherein the optical switches include one or more of:
1×2 optical switches; or
1×4 optical switches.

12. The method of claim 10, wherein the measurement data includes power loss measurement data for a set of optical signals, in an optical fiber, in two opposite directions.

13. The method of claim 12, wherein processing the measurement data includes:
using the power loss measurement data for the optical signals in the two directions to eliminate false gains and false losses in the measurement data.

14. The method of claim 10, wherein the optical network includes waver couplers that optically connect the optical switches to the optical fibers.

15. The method of claim 10, further comprising:
configuring the OTDRs to operate during normal operation of the optical network; and
obtaining periodic measurement data from the OTDRs during the normal operation of the optical network.

16. The method of claim 15, wherein the periodic measurement data includes Brillouin backscattering data.

17. The method of claim 15, wherein sending first control signals to the optical switches includes sending the first control signals prior to the normal operation of the optical network.

18. The method of claim 10, wherein the optical network includes at least one or more of:
optical transmitters, optical receivers, and optical amplifiers.

19. A non-transitory computer-readable medium comprising processor-executable instructions, which when executed by the processor, cause the processor to:
send first control signals to optical switches to optically connect embedded optical time domain reflectometers (OTDRs), of an optical network, to optical fibers of the optical network;
send second control signals to the OTDRs to measure attenuations of optical signals in the optical fibers;
receive measurement data from the OTDRs as results of measuring the attenuations of the optical signals in the optical fibers;
process the measurement data; and
determine whether the optical fibers meet a performance requirement based on the processed measurement data.

20. The non-transitory computer-readable medium of claim 19, wherein the optical switches include one or more of:
1×2 optical switches; or
1×4 optical switches.
